(19) United States
(12) Patent Application Publication
(10) Pub. No.: US 2009/0323778 A1
(43) Pub. Date: Dec. 31, 2009

(54) MULTIMODE RECEIVER ARCHITECTURE

(75) Inventors: Jason P. Woodard, Cambridge (GB); Andrew Papageorgiou, Lower Cambourne (GB); Diego Giancola, Cambridge (GB)

Correspondence Address: BLANK ROME LLP, WATERGATE, 600 NEW HAMPSHIRE AVENUE, N.W., WASHINGTON, DC, 20037, US

(73) Assignee: Cambridge Silicon Radio Limited, Cambridge (GB)

(21) Appl. No.: 12/164,770

(22) Filed: Jun. 30, 2008

(51) Int. Cl. H04B 1/707; H04B 1/10

(52) U.S. Cl. 375/148; 375/348; 375/E01.032

(57) ABSTRACT

A radio receiver comprising a compensator arranged to compensate for intersymbol interference in a signal received at the receiver and a configurator arranged to configure the compensator, wherein the compensator comprises a programmable filter and the configurator is capable of configuring the filter in a first mode to operate as an ISI equaliser or in a second mode to implement a RAKE finger set.

### FIELD OF THE INVENTION

The invention relates to the field of digital communications conducted by means of radio frequency (RF) carrier signals.

### BACKGROUND OF THE INVENTION

In normal practice, digital signals are converted into streams of modulation symbols, for example using a modulation scheme such as QPSK, and then modulated onto RF carrier signals. Receivers that are configured to handle signals that have been modulated in this way attempt to isolate a wanted received carrier signal and then demodulate the stream of symbols from the RF carrier signal. However, it is likely that the carrier signal will reach the receiver via a number of different paths, with the result that a number of versions of the carrier signal arrive at the receiver, all at different delays. This is the well known phenomenon of multipath propagation, which gives rise to intersymbol interference (ISI) in the demodulated signal. That is to say, the delay between two multipath components can be such that at some given instant, the receiver experiences different symbols from the two paths. It is well known to use an equaliser or a RAKE receiver to compensate or correct for intersymbol interference.

### SUMMARY OF THE INVENTION

According to one aspect, the invention provides a radio receiver comprising a compensator arranged to compensate for intersymbol interference in a signal received at the receiver and a configurator arranged to configure the compensator, wherein the compensator comprises a programmable filter and the configurator is capable of configuring the filter in a first mode to operate as an ISI equaliser or in a second mode to implement a RAKE finger set. The invention also consists in a method of compensating for intersymbol interference in a signal received at a receiver, the method comprising configuring a programmable filter and applying the filter to the signal in the compensation of ISI, wherein the configuring step comprises selecting a configuration for the filter from a set including a first filter configuration in which the filter operates as an ISI equaliser and a second filter configuration in which the filter implements a RAKE finger set.

Thus, the invention provides a relatively compact architecture that can change between RAKE and equaliser solutions to the ISI problem as conditions dictate.

The radio receiver may be compliant with the WCDMA standards that are maintained by 3GPP.

The radio receiver may, for example, form part of a handset of a mobile telephone or part of a base station in a cellular telecommunications network.

Although the invention involves a selection between RAKE and equaliser solutions to the ISI problem, it is to be understood that the invention also extends to the case where an ISI solution is selected from a larger group of available solutions, of which the RAKE and equaliser solutions are two.

### BRIEF DESCRIPTION OF THE DRAWINGS

By way of example only, certain embodiments of the invention will now be described with reference to the accompanying drawings, in which:

FIG. 1 is a block diagram schematically illustrating a mobile telephone handset from the perspective of its role as a radio receiver;

FIG. 2 is a block diagram schematically illustrating the structure of a finite impulse response filter;

FIG. 3 is a block diagram schematically illustrating the structure of a cell of the FIR filter depicted in FIG. 2;

FIG. 4 is a diagram showing a channel impulse response and a chain of cells in an FIR filter that is being configured for use as part of a RAKE receiver; and

FIG. 5 shows the chain of FIR filter cells as configured in FIG. 4 feeding into the adder unit of the filter.

### DETAILED DESCRIPTION OF THE PREFERRED EMBODIMENTS

Various of the diagrams in this document illustrate circuits and systems and it will be understood by persons skilled in the field of digital communications that the elements appearing in these figures serve to illustrate functions that are performed in the various circuits and systems and do not necessarily correspond to actual components.

In general terms, a data signal, comprising a series of bits, that is to be transmitted over the air interface in a WCDMA network is first subjected to forward error correction (FEC) coding. The resulting signal, again comprising a series of bits, is then encoded as a series of constellation symbols belonging to a modulation scheme (and there may be multiple bits of the FEC-encoded signal represented by each modulation symbol), with the symbols then being divided into shorter duration chips by spreading and scrambling processes. The details of this sequence of processes will be familiar to engineers skilled in the field of digital communications and this sequence of processes must be retraced in a receiver in order to recover the transmitted data signal.

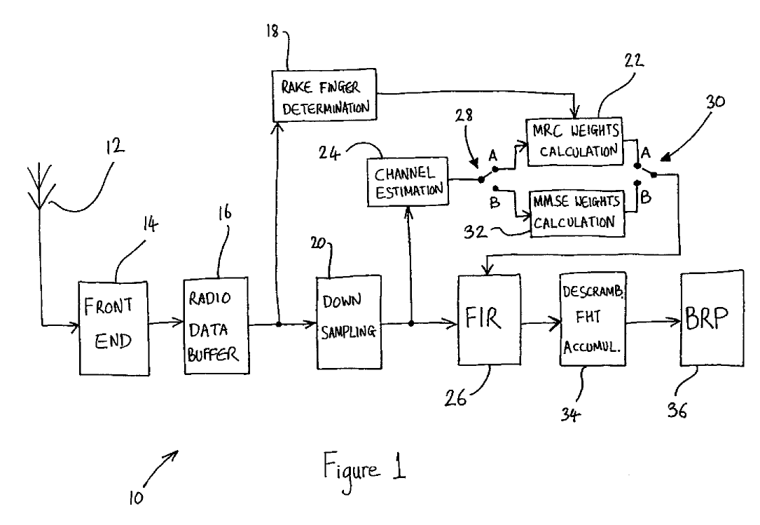

FIG. 1 illustrates schematically a WCDMA handset 10 from the perspective of its role as a wireless signal receiver and shows only those elements necessary for describing the invention. It will be understood by engineers skilled in the field of digital communications that, in practice, the handset 10 will contain other elements besides those shown in FIG. 1.

The handset 10 has an antenna 12 for receiving wireless communications. The antenna 12 picks up radio signals in the vicinity of the handset 10 and supplies them to an RF front end module 14 for processing. The RF front end module 14 uses filtering to isolate an RF signal in a wanted channel of the WCDMA network to which the handset 10 belongs. The RF front end module 14 is also tasked with amplifying the isolated RF signal and demodulating it, for example by direct downconversion, to produce a baseband signal, representing the chip rate signal that was modulated onto an RF carrier in the transmitter. The RF front end module 14 then digitises this baseband signal with a sampling rate that is eight times higher than the chip rate that resulted when the data signal was scrambled and spread during preparation for its transmission. This % 8 oversampled chip rate signal is then fed into a radio data buffer 16. The % 8 oversampled baseband signal from the radio data buffer 16 is delivered to a finger determination unit 18 and to a downsampling unit 20.

The finger determination unit 18 identifies in a known manner a predetermined number of the strongest multipath components within the signal supplied from the radio data buffer 16. The finger determination unit 18 calculates the RAKE finger positions to a ⅛ chip resolution from the % 8 oversampled baseband signal. The finger determination unit 18 then provides an MRC weights calculation unit 22 with the RAKE finger positions for a purpose that will be described later. In the main signal path, the downsampling unit 20 reduces the degree of oversampling of the signal provided by the radio data buffer 16 from % 8 to % 2. The % 2 oversampled signal provided by the downsampling unit 20 is then supplied to both a channel estimation unit 24 and to a finite impulse response (FIR) filter 26.

The channel estimation unit 24 calculates a % 2 oversampled channel impulse response from the % 2 oversampled signal provided by the downsampling unit 20. Schemes for calculating a channel impulse response from the baseband signal will be well known to engineers skilled in the field of digital communications. The channel impulse response estimate is delivered to a switch 28. The switch 28 introduces two parallel processing paths that converge in a further switch 30. These parallel paths provide alternative mechanisms for calculating a set of complex-valued filter coefficients to configure the FIR 26.

Switch 28 has A and B outputs and switch 30 has A and B inputs. The switches 28 and 30 operate as a pair and together can assume one of two states. In one state, the switch 28 connects its input to its A output and switch 30 connects its output to its A input. When the switches 28 and 30 are in this state, the handset 10 shall be said to be in RAKE receiver mode. The other state that can be adopted by the switches 28 and 30 is when switch 28 connects its input to its B output and switch 30 connects its output to its B input. When the switches are in this state, the handset 10 shall be said to be in equaliser mode.

The operation of the handset 10 in equaliser mode shall now be described.

### Equaliser Mode

In equaliser mode, the channel impulse response estimate produced by channel estimation unit 24 is supplied via switch 28 to an MMSE weights calculation unit 32. MMSE weights calculation unit performs the calculations that are necessary to produce the set of filter coefficients that will configure the FIR filter 26 to operate as a minimum mean-square error (MMSE) equaliser. The calculations that are needed to deduce this set of filter coefficients from the channel impulse response estimate provided by channel estimation unit 24, which include a relatively computationally intensive matrix inversion step, will be known to engineers skilled in the field of digital communications and so will not be described in detail here.

With the FIR 26 thus programmed, the output of the FIR filter is an equalised version of the % 2 oversampled baseband signal. The equalised % 2 oversampled baseband signal produced by the FIR filter 26 is then supplied to symbol rate conversion unit 34 where the signal undergoes various operations such as despreading, descrambling, fast Hadamard transformation (FHT) and symbol-length accumulation to produce a complex-valued digital signal comprising a stream of symbols. The stream of symbols produced by symbol conversion unit 34 is supplied to a bit rate processor (BRP) 36 where any forward error correction (FEC) coding is decoded to recover a data signal which is then put to its intended use, such as conversion to an analogue audio signal that is played through a loud speaker or rendition as a web page that is shown on an LCD display.

### RAKE Mode

In RAKE mode, the % 2 oversampled channel impulse response estimate is provided to the MRC weights calculation unit 22. It will be recalled that the MRC weights calculation unit 22 also receives as an input the set of finger positions deduced by finger determination unit 18. The MRC weights calculation unit 22 maps the finger positions onto the channel impulse response estimate. The finger positions are specified to a ⅛ chip resolution but the MRC weights calculation unit 22 nevertheless identifies the samples within the ½ chip resolution channel impulse response estimate that best correspond to the finger positions. Thus, for each finger position, the MRC weights calculation unit 22 identifies a corresponding channel impulse response estimate value. Next, the MRC weights calculation unit 22 deduces a RAKE finger coefficient for each finger position by calculating the complex conjugate of the channel impulse response estimate value that has been mapped to the finger. Thus, a RAKE finger coefficient is deduced for each member of the set of RAKE finger positions. The set of RAKE finger positions, each with its corresponding RAKE finger coefficient, is then deployed in the FIR filter 26 to cause the FIR filter to operate in conjunction with symbol rate conversion unit 34 as a RAKE receiver. Before describing this configuration of the FIR filter 26 in more detail, a brief discussion of the structure of the FIR filter will first be provided.

FIG. 2 shows the structure of FIR filter 26. The % 2 oversampled baseband signal s is supplied to a chain of N cells, e.g. 38. The samples of signal s shift one place to the right along the chain of cells with every clock cycle. Also, each cell in the chain sends an output to an adder 40. The sum value produced by adder 40 represents the sample of the digital output signal that the FIR filter 26 presents to unit 34 in the current clock cycle.

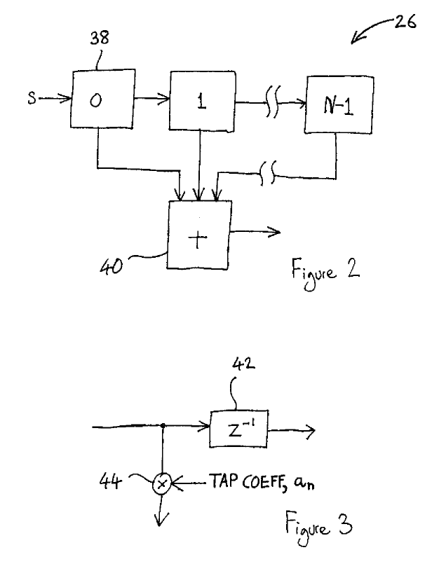

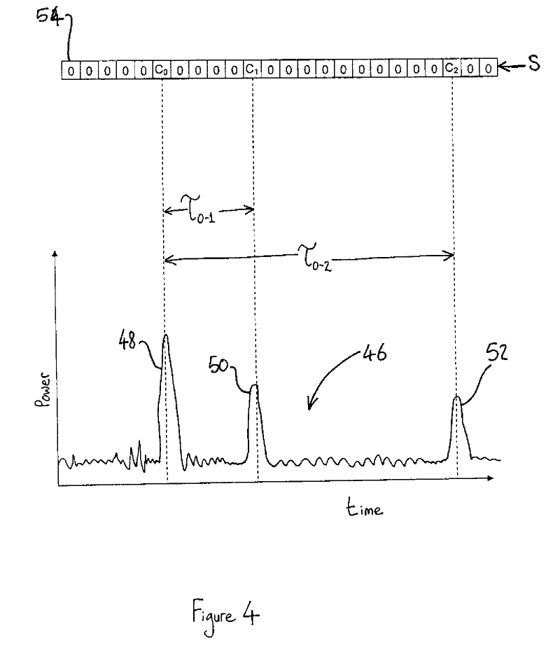

FIG. 3 illustrates a typical cell of the chain shown in FIG. 2. The sample of signal s that is received from the preceding cell in the chain (or which is presented at the filter's input in the case of cell 38) is supplied both to a one clock cycle delay element 42 and to a multiplier 44. The output of the delay element provides the input to the next element in the chain. In the multiplier 44, the input to the cell is multiplied with a so-called “tap coefficient” to produce the output that is passed to the adder 40. All the cells have this configuration, except the cell numbered N-1 which does not require the delay element. Each cell in the FIR filter 26 has its own tap coefficient, the tap coefficient of the n^{th} cell being denoted aₙ. It is well known that the characteristics of an FIR filter, e.g. its pass band, can be determined by setting these tap coefficients appropriately.

Returning now to the discussion of RAKE mode operation, the MRC weights calculation unit 22 sets the tap coefficients along the chain to zero except at the positions where RAKE fingers are specified in the aforementioned RAKE finger allocation. At each position along the chain where a RAKE finger falls, the cell is given as its tap coefficient the RAKE finger coefficient deduced for the respective finger. This configuration of the tap coefficients will now be explained further with the help of an example involving FIG. 4.

The bottom part of FIG. 4 shows a channel impulse response 46 plotting power (vertically) versus time (horizontally). The channel impulse response plot contains three prominent peaks 48, 50 and 42. The time delay between peaks 48 and 50 is τ₀₋₁ and the time delay between peaks 48 and 52 is τ₀₋₂. Consider now the case where the handset 10 is operating in RAKE mode and the MRC weights calculation unit 22 is required to configure the tap coefficients of the FIR filter 26 for RAKE mode operation given the channel impulse response 46 and that RAKE fingers have been allocated to peaks 48, 50 and 52 only (fingers 0 to 2, respectively).

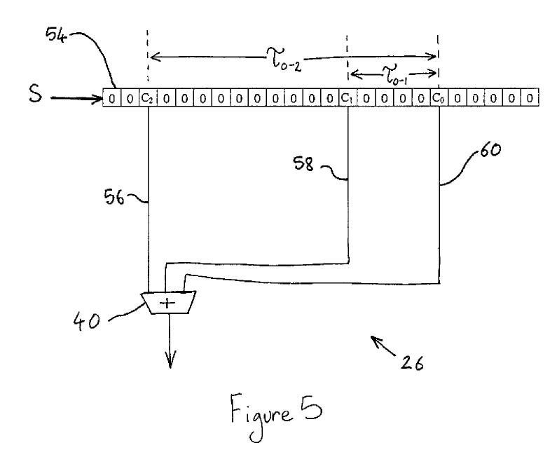

The strip 54 at the top of FIG. 4 represents a part of the chain of cells in the FIR filter 26. It is to be carefully noted, however, that in this figure the chain of cells is shown with signal s flowing through the chain from right to left and not left to right as in FIGS. 3 and 5. Each rectangle in the strip 54 represents a cell in the chain. The value shown in each cell represents the tap coefficient of that cell. The MRC weights calculation unit 22 deduces finger coefficients C₀, C₁ and C₂ for fingers 0, 1 and 2 respectively. These finger coefficients are loaded into the chain of cells such that the time offset between the cells containing C₀ and C₁ is τ₀₋₁ and such that the time offset between the cells containing C₀ and C₂ is τ₀₋₂. Besides these cells, all of the FIR filter's tap coefficients are set to zero. In this way, the FIR filter 26 functions like three RAKE fingers. That this configuration of the FIR filter 26 results in RAKE mode operation will be clearer when FIG. 5 is considered.

In FIG. 5 the chain of cells 54 is shown together with the adder 40 that makes up the FIR filter 26. In FIG. 5, the signal s flows from left to right through the chain 54 of filter cells. As in FIG. 4, the values shown in these cells denote the tap coefficients of the cells. Only the paths from the cells containing coefficients C₂, C₁ and C₀ are shown as feeding into the adder 40 since the paths from the other cells are effectively switched off by their zero-valued tap coefficients. The paths 56, 58 and 60 are, in effect, RAKE fingers: each of these paths conveys the % 2 oversampled baseband signal at a time offset relative to the other two paths and each path contains a multiplier, in its respective cell of chain 54, that applies a respective RAKE finger coefficient to derotate the version of the % 2 oversampled baseband signal s that is travelling along the respective path. The only difference between the representation shown in FIG. 5 and a traditional RAKE receiver layout is that the symbol rate conversion process is not replicated in each of the paths 56, 58 and 60 but is instead performed singly, at a point downstream from the adder 40, in the symbol rate conversion unit 34.

The path 60 represents the earliest RAKE finger, which corresponds to peak 48 in FIG. 4 and for which RAKE finger coefficient C₀ has been deduced by the MRC weights calculation unit 22. Path 58 represents a RAKE finger allocated to the next significant multipath component to arrive at the antenna 12, which is indicated by peak 50 in FIG. 4. The RAKE finger of path 58 is delayed by an interval τ₀₋₁ relative to path 60. Path 56 represents a RAKE finger allocated to the third, and latest arriving, significant multipath component, which is represented by peak 52 in FIG. 4 and for which RAKE finger coefficient C₂ was calculated. The version of signal S that travels along the RAKE finger represented by path 56 is delayed by an interval τ₀₋₂ relative to the leading RAKE finger represented by path 60.

The output of the adder 40 of the FIR filter 26 is supplied to the symbol rate conversion unit 34 where the descrambling despreading and accumulation processes that are required to complete the RAKE processing are performed. The stream of symbols produced by symbol conversion unit 34 is supplied to a bit rate processor (BRP) 36 where any forward error correction (FEC) coding is decoded to recover a data signal which is then put to its intended use, such as conversion to an analogue audio signal that is played through a loud speaker or rendition as a web page that is shown on an LCD display.

In the embodiment described above, the finger determination unit 18 calculates the finger positions for use by the MRC weights calculation unit 22 from the % 8 oversampled baseband signal from the radio data buffer 16. In one alternative embodiment, the finger determination unit 18 calculates the finger positions by applying a peak detection algorithm to the % 2 oversampled channel impulse response estimate provided by the channel estimation unit 24.

1. A radio receiver comprising a compensator arranged to compensate for intersymbol interference in a signal received at the receiver and a configurator arranged to configure the compensator, wherein the compensator comprises a programmable filter and the configurator is capable of configuring the filter in a first mode to operate as an ISI equaliser or in a second mode to implement a RAKE finger set.

2. A radio receiver according to claim 1, wherein, in the second mode, the filter is configured to time align and combine several multipath components of the signal for collective conversion from chip rate to symbol rate.

3. A radio receiver according to claim 1, wherein, for the second mode, the configurator is arranged to map a RAKE finger position set onto a channel impulse response estimate for said signal in order to obtain channel impulse response values for the RAKE finger set, from which RAKE finger derotation coefficients may be calculated.

4. A radio receiver according to claim 1, that is compatible with WCDMA.

5. A method of compensating for intersymbol interference in a signal received at a receiver, the method comprising configuring a programmable filter and applying the filter to the signal in the compensation of ISI, wherein the configuring step comprises selecting a configuration for the filter from a set including a first filter configuration in which the filter operates as an ISI equaliser and a second filter configuration in which the filter implements a RAKE finger set.

6. A method according to claim 5, wherein, in the second filter configuration, the filter is configured to time align and combine several multipath components of the signal for collective conversion from chip rate to symbol rate.

7. A method according to claim 5, wherein, for the second filter configuration, the configuring step further comprises mapping a RAKE finger position set onto a channel impulse response estimate for said signal in order to obtain channel impulse response values for the RAKE finger set, from which RAKE finger derotation coefficients may be calculated.

8. A method according to claim 5, wherein the radio receiver is compatible with WCDMA.
